(19) United States
(12) Patent Application Publication
(10) Pub. No.: US 2015/0332426 A1
(43) Pub. Date: Nov. 19, 2015

(54) TRANSFORMABLE COMPUTING DEVICE WITH PARALLEL PROCESSING CPUS AND DISCRETE GPU

(71) Applicants: Hong Fu Jin Precision Industry (WuHan) Co., Ltd., Wuhan (CN); Hon Hai Precision Industry Co., Ltd., New Taipei (TW)

(72) Inventor: CHIH-SHENG HSIEH, New Taipei (TW)

(73) Assignees: Hon Hai Precision Industry Co., Ltd., New Taipei (TW); Hong Fu Jin Precision Industry (WuHan) Co., Ltd., Wuhan (CN)

(21) Appl. No.: 14/279,519

(22) Filed: May 16, 2014

(51) Int. Cl. G06T 1/20; G06F 1/16

(52) U.S. Cl. CPC G06T 1/20; G06F 1/1654; G06F 1/1669; G06T 2210/52

(57) ABSTRACT

A transformable computing device has a detachable first part with a main central processing unit (CPU), a second part having an display and a secondary CPU, and a detachable third part having a graphical processing unit (GPU). The main CPU can work with the secondary CPU via parallel processing means when the first part is connected to the second part; and the display of the second part can run on the GPU when the third part is connected to the second part.

### FIELD

The present disclosure generally relates to computing devices and, particularly, to a transformable computing device with parallel processing central processing units (CPUs) and/or a discrete graphical processing unit (GPU).

### BACKGROUND

The computing devices that are capable of transforming (hereinafter “transformable computing devices”), such as transformable tablets, currently on the market often have a detachable cell phone part, a tablet part and, optionally, a detachable keyboard part. The transformable computing device can be used as a cell phone, a tablet computer or a laptop computer.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a diagrammatic view illustrating a transformable computing device in accordance with an embodiment.

FIG. 2 is a block diagram depicting a first embodiment of the transformable computing device of FIG. 1.

FIG. 3 is another block diagram depicting a second embodiment of the transformable computing device of FIG. 1.

FIG. 4 is yet another block diagram depicting a third embodiment of the transformable computing device of FIG. 1.

### DETAILED DESCRIPTION

The embodiments are to be described and disclosed in the following paragraphs in detail with reference to the accompanying drawings. The disclosure is illustrated by way of example and is not limited by the figures of the accompanying drawings in which like references indicate similar elements.

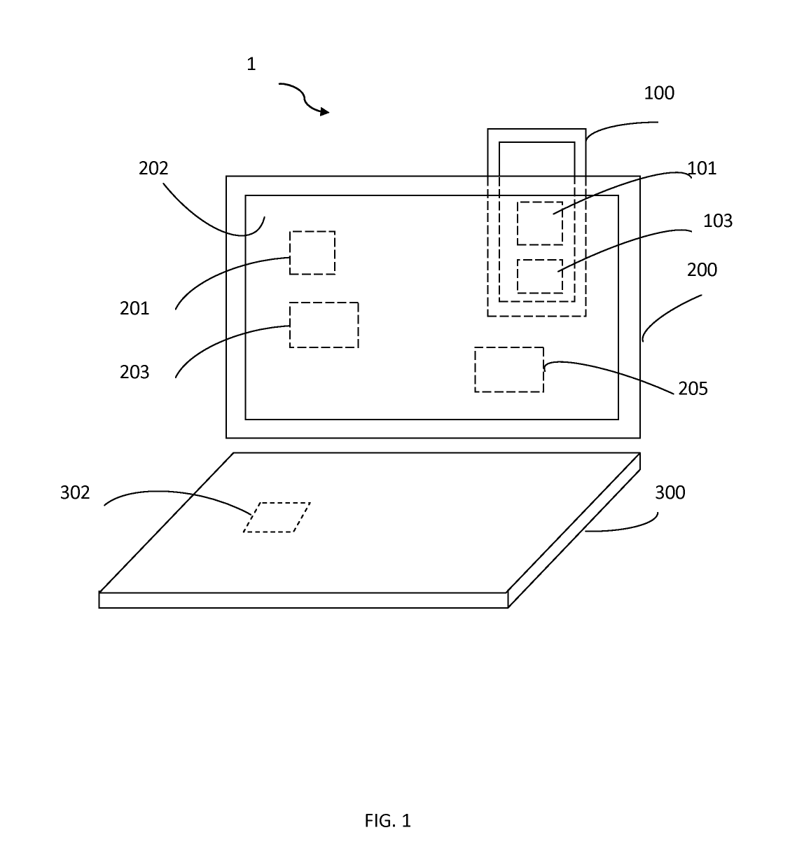

Referring to FIG. 1, an exemplary embodiment of a transformable computing device 1 includes a first part 100, a second part 200 and a third part 300. The first part 100 and the third part 300 can be detached from or coupled to the second part 200 such that the three parts can be separated or coupled together. The first part 100 can be a cell phone unit having its own CPU 101 and GPU 103. The second part 200 is a tablet part including a display 202. The third part 300 can be a detachable keyboard. When the first part 100 is detached from the second part 200, the first part 100 can be used as a cell phone; when the first part 100 is attached to the second part 200, and the third part 300 is detached from the second part 200, the second part 200, together with the first part 100, can be used as a tablet computer; and when all three parts are connected together, they can function like a laptop computer.

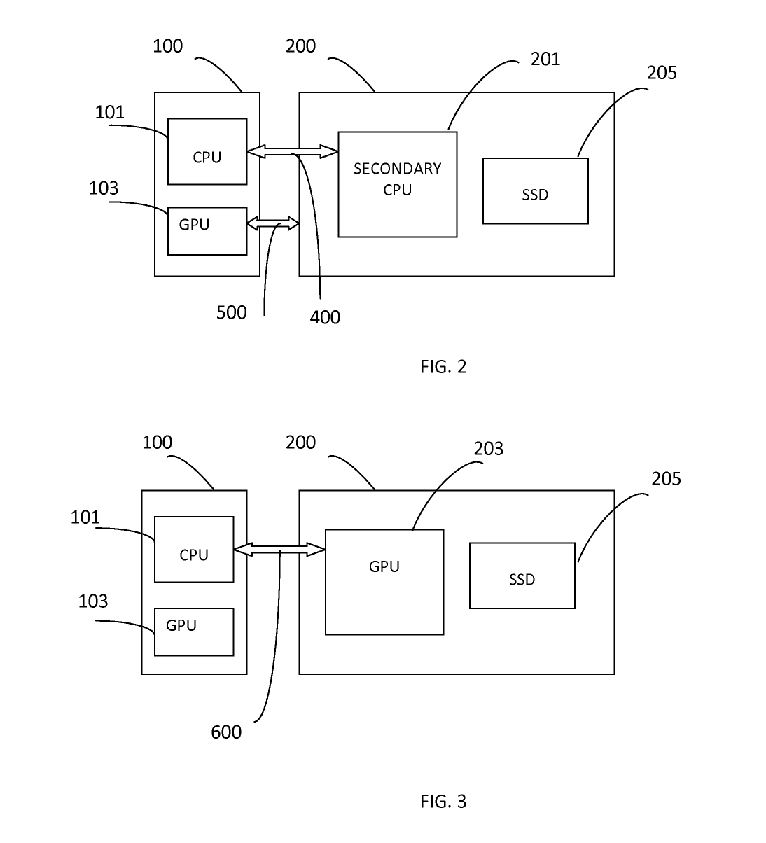

Referring to FIG. 2, together with FIG. 1, in one embodiment, the second part 200 can have a CPU 201. When the first part 100 is attached to the second part 200, the CPU 201 can function as a secondary CPU to increase processing power of the computing device 1. For instance, the connection 400 between the CPU 101 of the first part 100 and the CPU 201 can be achieved via a parallel processing (or paralleling computing) device or structure, implementing such as Simple Instruction Multiple Data (SIMD), or Multiple Instruction Multiple Data (MIMD) modules. With parallel processing connection 400, the CPU 201 can improve the processing power of the transformable computing device, enabling large-scale programs to run smoothly (such as some large-scale computer games, AUTOCAD, PRO-E, etc.). In addition, the second part 200 can include a storage unit 205, such as a solid state disk, to increase memory space to help processing data. The display 202 of the second part 200 can run on GPU 103 via connection 500 between the GPU 103 and the second part 200, controlled by the CPU 101, or in addition, together with CPU 201.

In another embodiment as shown in FIG. 3, in order to improve graphical proceeding power, the second part 200 can have its own GPU 203. When the first part 100 is attached to the second part 200, the GPU 203 is controlled by the CPU 101 to power the display 202. This way, the second part 200 will can have enough graphical processing power to run some graphically-intensive applications, such as PHOTOSHOP, CORELDRAW, etc. Optionally, the storage unit 205 can be included to provide increased memory space for graphical processing.

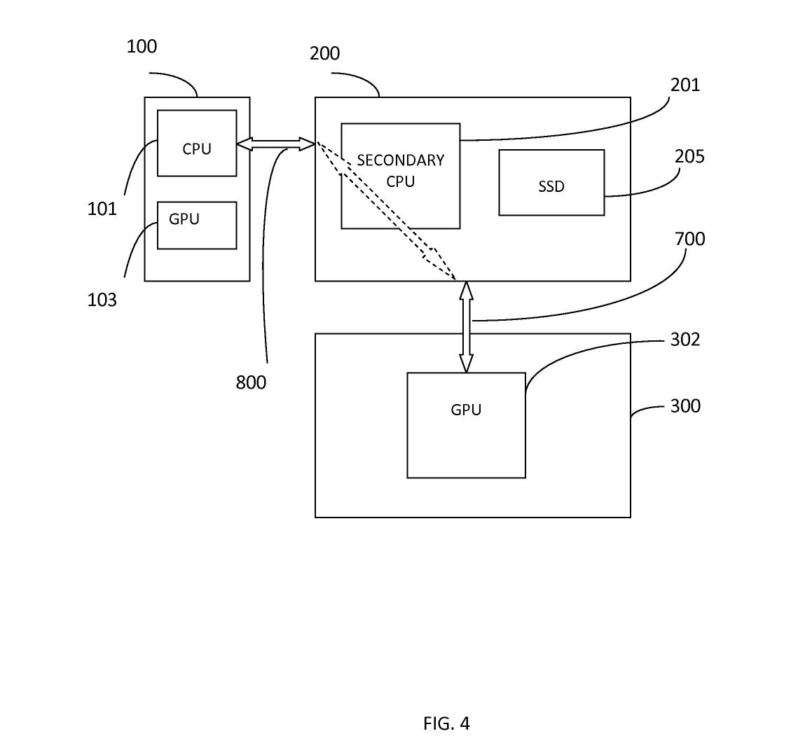

Referring to FIG. 4, in another embodiment, the third part 300, e.g., a keyboard part, can include a GPU 302. When the third part 300 is connected to the second part 200 via connection 700, the GPU 302 is controlled by the CPU 101 which is connected to the second part 200 via connection 800. The display 202 can run on the GPU 302 controlled by the CPU 101. Optionally, the second part 200 can still have the CPU 201, functioning as a secondary CPU to work together with the CPU 101 in a parallel computing way, and the storage unit 205 to provide more memory space.

While certain embodiments have been described and exemplified above, various other embodiments will be apparent from the foregoing disclosure to those skilled in the art. The disclosure is not limited to the particular embodiments described and exemplified but is capable of considerable variation and modification without departure from the scope and spirit of the appended claims.

What is claimed is:

1. A transformable computing device, comprising:
a detachable first part comprising a first central processor unit (CPU) and a graphical processing unit (GPU); and
a second part comprising a second CPU and a display,
wherein, when the first part is coupled to the second part, the first CPU is connected to the second CPU via parallel processing means, and the display runs on the GPU.

2. The computing device of claim 1, wherein the second part further comprises a storage unit accessible by the first CPU when the first part is connected to the second part.

3. The computing device of claim 2, wherein storage unit is a solid state disk.

4. The computing device of claim 1, wherein the first part is a cell phone.

5. A transformable computing device, comprising:
a detachable first part comprising a central processor unit (CPU); and
a second part comprising a graphical processing unit (GPU) and a display,
wherein, when the first part is attached to the second part, the CPU controls the GPU and the display runs on the GPU.

6. The computing device of claim 5, wherein the second part further comprises a storage unit accessible by the CPU when the first part is connected to the second part.

7. The computing device of claim 6, wherein storage unit is a solid state disk.

8. The computing device of claim 5, wherein the first part is a cell phone.

9. A transformable computing device, comprising:
a detachable first part comprising a first central processor unit (CPU);
a second part comparing a display; and
a detachable third part comprising a graphical processing unit (GPU),
wherein, when the first part is attached to the second part and the third part is attached to the second part, the first CPU controls the GPU and the display runs on the GPU.

10. The computing device of claim 9, wherein the second part further comprises a second CPU, and when the first part is attached to the second part, the first CPU is connected to the second CPU via parallel processing means.

11. The computing device of claim 9, wherein the second part further comprises a storage unit accessible by the first CPU when the first part is connected to the second part.

12. The computing device of claim 11, wherein storage unit is a solid state disk.

13. The computing device of claim 9, wherein the first part is a cell phone.

14. The computing device of claim 9, wherein the third part is a keyboard.
